(19) United States
(12) Patent Application Publication
(10) Pub. No.: US 2021/0336580 A1
(43) Pub. Date: Oct. 28, 2021

(54) SELF-ALIGNING PANEL CLEANER

(71) Applicant: Cordelle Industries, Inc., San Luis Obispo, CA (US)

(72) Inventor: Sterling TWISSELMAN, San Luis Obispo, CA (US)

(21) Appl. No.: 17/243,506

(22) Filed: Apr. 28, 2021

Related U.S. Application Data
(60) Provisional application No. 63/016,879, filed on Apr. 28, 2020.

(51) Int. Cl. H02S 40/10; B08B 3/02; B08B 1/00; B05B 13/00; B05B 1/20

(52) U.S. Cl. CPC H02S 40/10; B08B 3/024; B05B 1/20; B05B 13/005; B08B 1/002

(57) ABSTRACT

Disclosed is a self-aligning device, apparatus, and method for cleaning panels including photovoltaic panels. In an embodiment of the invention, a panel cleaner comprises a manifold, a plurality of nozzles operatively connected to the manifold, wherein the manifold supplies fluid to the plurality of nozzles, a guide comprising a hub and a plurality of spokes extending radially from the hub, wherein the guide is rotatable about an axis defined by a concentric center of the hub, and a plurality of wheels. In another embodiment of the invention, a method of cleaning an array of panels with a panel cleaner, each panel positioned adjacent to at least one other panel forming a panel gap between said panels, the steps comprising: inserting a guide spoke of a first guide within the panel gap, the guide spoke connected to a hub flange of a first hub assembly, wherein the first hub assembly is attached to a first axle; spraying pressurized fluid from a plurality of nozzles operatively connected to a manifold, the manifold offset from the first axle by an upright; and moving the panel cleaner over the surfaces of the panels in the array of panels using a plurality of wheels in a direction parallel to the panel gap in which the guide spoke is inserted.

### CROSS-REFERENCE TO RELATED APPLICATIONS

The present application claims priority to U.S. Provisional Application No. 63/016,879 filed on Apr. 28, 2020 and entitled, “Panel Cleaner,” the entire disclosure of which is incorporated herein by reference.

### BACKGROUND OF INVENTION

### 1. Field of Invention

This invention relates to cleaning devices and, more specifically, a cleaning device and apparatus for panels.

### 2. Description of Related Art

Photovoltaic facilities, also known as solar farms, typically include photovoltaic (PV) panels (also referred to as solar panels). The PV panels have reduced output when the surface of the panel is dirty. Therefore, it is desirable for the PV panels to be periodically cleaned to maintain maximum output levels. Solar farms generally include large numbers of solar panels mounted on the ground in multiple rows, with the solar panels tilted upward at an angle with respect to the ground. Such panel arrays are difficult and cumbersome to clean using conventional methods.

Systems and methods known in the art for cleaning PV panels include manual washing with purified water and/or suitable cleaning products. However, this method is slow and requires a large amount of labor. Also, cleaning PV panels using existing techniques is slow as it requires a user to cleaning a large amount of surface area. Existing techniques require many bulky components that requires the user to carry around and set up. Additionally, the user must constantly adjust the equipment during the cleaning process, thereby slowing the entire process and making it more labor intensive.

In light of these challenges in the field, there exists a need for a cleaning device and/or apparatus that allows the user to clean multiple panels quickly and efficiently without damaging the panels. This need has remained heretofore unsatisfied.

### SUMMARY OF THE INVENTION

The present invention overcomes these and other deficiencies of the prior art by providing a self-aligning panel cleaner that allows a user to clean an array of panels easily and simply.

In an exemplary embodiment of the present disclosure, a panel cleaner comprises a manifold, a plurality of nozzles operatively connected to the manifold, wherein the manifold supplies fluid to the plurality of nozzles, a guide comprising a hub and a plurality of spokes extending radially from the hub, wherein the guide is rotatable about an axis defined by a concentric center of the hub, and a plurality of wheels. In another embodiment, the cleaner further comprises a first axle, wherein the guide is attached to the first axle and the manifold is offset from the first axle via an upright; a second axle oriented generally parallel to the first axle and offset from the first axle via a first extension; and a third axle oriented generally parallel to the first axle and offset from the first axle via a second extension.

In another exemplary embodiment, the cleaner further comprises a second guide attached to the second axle, the second guide comprising a plurality of spokes extending radially from a second hub, wherein the second guide is rotatable about an axis defined by a concentric center of the second hub.

In another exemplary embodiment, the cleaner further comprises a third guide attached to the third axle, the third guide comprising a plurality of spokes extending radially from a third hub, wherein the third guide is rotatable about an axis defined by a concentric center of the third hub.

In another exemplary embodiment, the cleaner further comprises a first wheel of the plurality of wheels that is disposed at a first terminal end of the first axle and a second wheel of the plurality of wheels is disposed at a second terminal end of the first axle opposite the first terminal end.

In another exemplary embodiment, the cleaner further comprises a third wheel of the plurality of wheels that is disposed at a first terminal end of the second axle and a fourth wheel of the plurality of wheels is disposed at a second terminal end of the second axle opposite the first terminal end.

In another exemplary embodiment, the cleaner further comprises a fifth wheel of the plurality of wheels that is disposed at a first terminal end of the third axle and a sixth wheel of the plurality of wheels is disposed at a second terminal end of the third axle opposite the first terminal end.

In another exemplary embodiment, the cleaner further comprises a bearing; and wherein each spoke rotates about an axis defined by its concentric center.

In another exemplary embodiment, the guide comprises a bearing; and wherein a portion of each spoke rotates about an axis defined by the spoke's concentric center.

In another exemplary embodiment, the cleaner further comprises a motor that drives at least one wheel of the plurality of wheels.

In another exemplary embodiment, the cleaner further comprises a fluid that is pressurized and the motor is a hydraulic motor that is powered by the pressurized fluid.

In another exemplary embodiment, the hub comprises a hub flange comprising a plurality of threaded holes perpendicular to the hub's rotational axis; and wherein each spoke of the plurality of spokes comprises a threaded rod threaded into a threaded hole of the plurality of threaded holes, a spoke tube disposed around the threaded rod, and a spoke nut threaded onto the threaded rod opposite the hub.

In another exemplary embodiment, the spoke tube comprises a semi-rigid material.

In another exemplary embodiment, the cleaner further comprises an on-board reservoir.

In another exemplary embodiment, the cleaner further comprises a second manifold.

In another exemplary embodiment, the cleaner further comprises a brush; wherein the panel cleaner is applied to photovoltaic panels.

In another exemplary embodiment of the present disclosure, a method of cleaning an array of panels with a panel cleaner, each panel positioned adjacent to at least one other panel forming a panel gap between said panels, the steps comprising: inserting a guide spoke of a first guide within the panel gap, the guide spoke connected to a hub flange of a first hub assembly, wherein the first hub assembly is attached to a first axle, spraying pressurized fluid from a plurality of nozzles operatively connected to a manifold, the manifold offset from the first axle by an upright; and moving the panel cleaner over the surfaces of the panels in the array of panels using a plurality of wheels in a direction parallel to the panel gap in which the guide spoke is inserted.

In another exemplary embodiment, the method further comprises inserting a guide spoke of a second guide within the panel gap, the guide spoke connected to a hub flange of a second hub assembly, wherein the second hub assembly is attached to a second axle.

In another exemplary embodiment, the method further comprises inserting a guide spoke of a second guide within a second panel gap, the guide spoke connected to a hub flange of a second hub assembly, wherein the second hub assembly is attached to a second axle.

In another exemplary embodiment, the array of panels is an array of photovoltaic panels, and wherein the panel cleaner is moved along the array of panels using a motor driving at least one wheel of the plurality of wheels.

According to another embodiment of the invention, the cleaning device comprises a body capable of supporting a plurality of wheels to allow the cleaner to move easily along the surface being cleaned, one or more guides that comprise one or more spokes to assist the cleaner in traveling in the desired direction, one or more uprights configured to support the manifold, a plurality of nozzles that are supplied with pressurized fluid. The pressurized fluid may comprise water and may further comprise additives such as soap or other additives that aid in cleaning, preserving, and/or treating the surface to be cleaned. The cleaner may also comprise a plurality of wheels that allow the cleaner to traverse the surface to be cleaned. The wheels are configured such that the cleaner can traverse multiple cleaning surfaces.

The cleaner may further comprise one or more guides. The guides locate the cleaner relative to spaces in the cleaning surface, e.g., panel gaps formed by each panel being positioned adjacent to another panel. Each guide may have a plurality of spokes, i.e., substantially straight members extending outward from the guide. For example, the guides may be aligned in a substantially linear orientation. In such an embodiment, the spokes can fit between a gap between two panels. The guides may further be configured to rotate about an axis. In such an embodiment, the locators can rotate around an obstruction in the gap, such as a retainer that holds the panels in place. In an embodiment comprising multiple guides, the guides keep the cleaner oriented in a desired direction, i.e., in line with the panels, by having at least one guide spoke engaging the panel gap.

The cleaner may be manually powered. In such an embodiment, the cleaner may have a handle extending from the cleaner's body. A user may use the handle to push or pull the cleaner along a plurality of panels. Other embodiments of manually powered cleaners comprise, for example, a rope affixed to one end of the cleaner. In such an embodiment, the user can place the cleaner at one end of a row of panels and pull the cleaner across the row of panels.

The cleaner may be powered. In some embodiments, the cleaner may comprise one or more motors that drive the cleaner across multiple panels. The motor may be powered by electricity or gasoline. In other embodiments, the cleaner may employ a hydraulic motor wherein the motor is driven by the hydraulic pressure of the pressurized fluid supplied to the cleaner.

The cleaner may further comprise cleaning aids that help clean the surfaces, such as a plurality of brushes that scrub the cleaning surface.

Although the invention may be shown and described as being used to clean a photovoltaic panel, the cleaner can be used to clean any type of panel or surface that is substantially horizontal and/or angled, flat or curved, without departing from the embodiments contemplated herein.

The foregoing, and other features and advantages of the invention, will be apparent from the following, more particular description of the preferred embodiments of the invention, and the accompanying drawings.

### BRIEF DESCRIPTION OF THE DRAWINGS

For a more complete understanding of the present invention, the objects and advantages thereof, reference is now made to the ensuing descriptions taken in connections with the accompanying drawings described as follows:

FIG. 1 illustrates an elevated isometric view of the panel cleaner, according to an exemplary embodiment of the present disclosure;

FIG. 2 illustrates a rear view of the panel cleaner, according to an exemplary embodiment of the present disclosure;

FIG. 3 illustrates a front view of the panel cleaner, according to an exemplary embodiment of the present disclosure;

FIG. 4 illustrates a side view of the panel cleaner, according to an exemplary embodiment of the present disclosure;

FIG. 5 illustrates a side view of the panel cleaner, according to an exemplary embodiment of the present disclosure;

FIG. 6 illustrates a top view of the panel cleaner, according to an exemplary embodiment of the present disclosure;

FIG. 7 illustrates a bottom view of the panel cleaner, according to an exemplary embodiment of the present disclosure;

FIG. 8 illustrates an isometric view of the panel cleaner with a handle connected, according to an exemplary embodiment of the present disclosure;

FIG. 9A illustrates an isometric view of the panel cleaner used on a panel array, according to an exemplary embodiment of the present disclosure;

FIG. 9B illustrates an isometric view of the panel cleaner used on a panel array with the nozzles spraying fluid, according to an exemplary embodiment of the present disclosure;

FIG. 10 illustrates an isometric view of the panel cleaner, according to an exemplary embodiment of the present disclosure; and

FIG. 11 illustrates a detail view of an exemplary guide, according to an exemplary embodiment of the present disclosure.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the instant disclosure covers all modifications, equivalents, and alternatives falling within the scope of the appended claims.

### DETAILED DESCRIPTION OF EXEMPLARY EMBODIMENTS

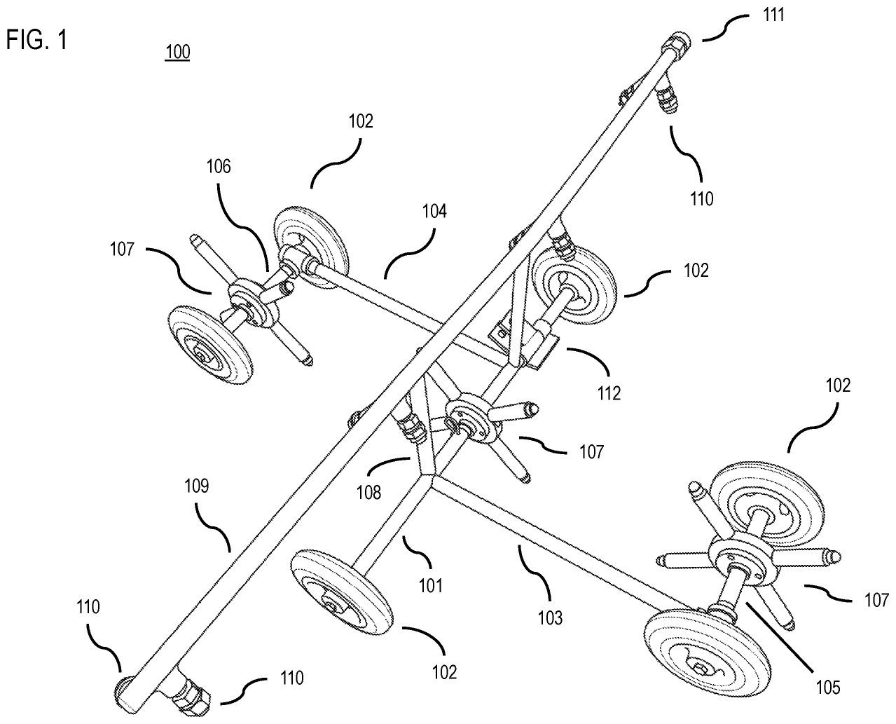

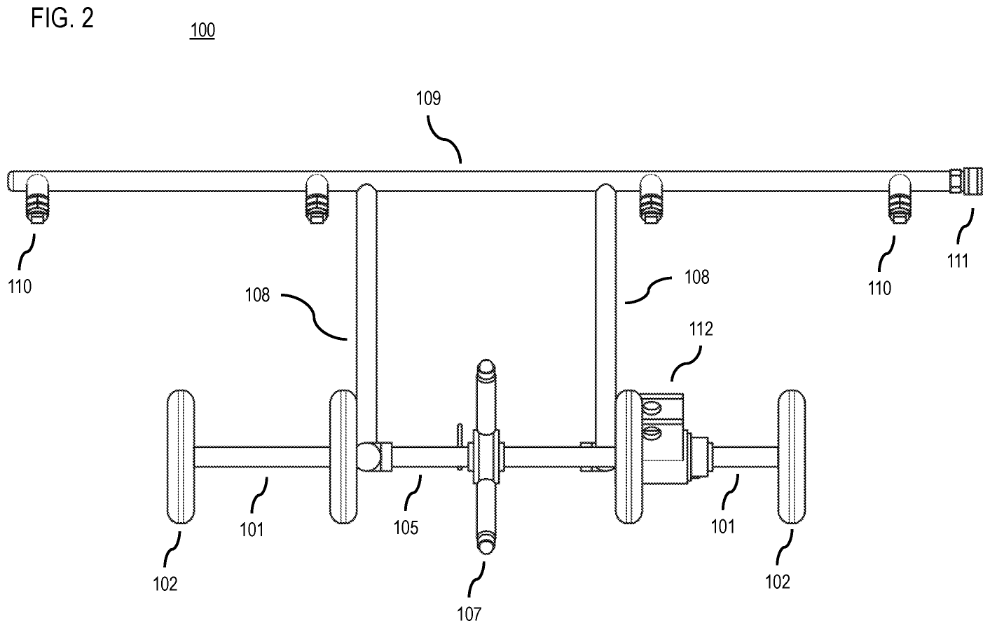

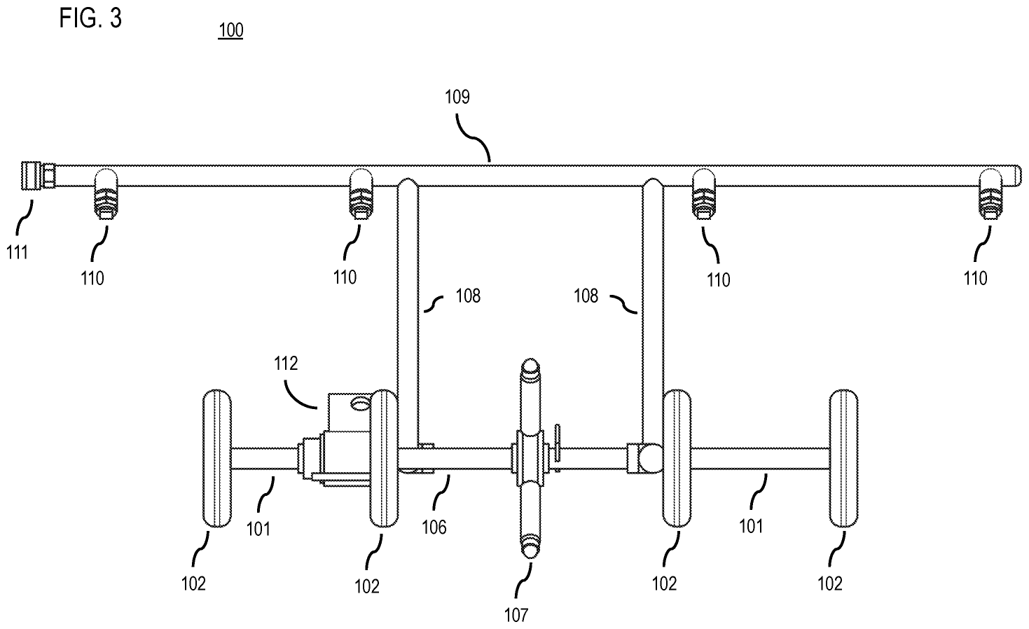

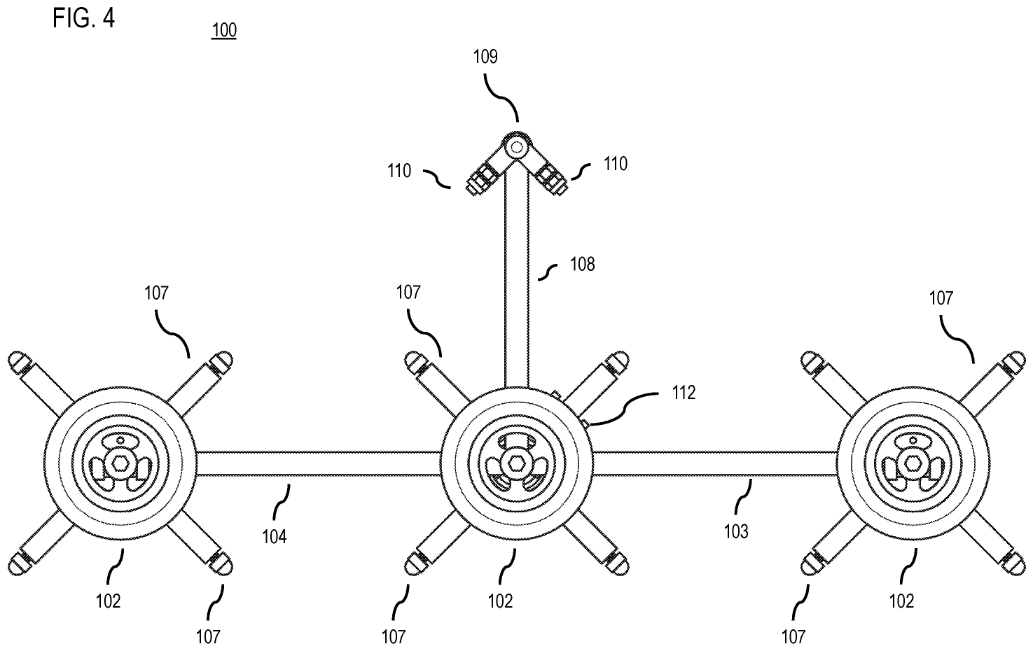

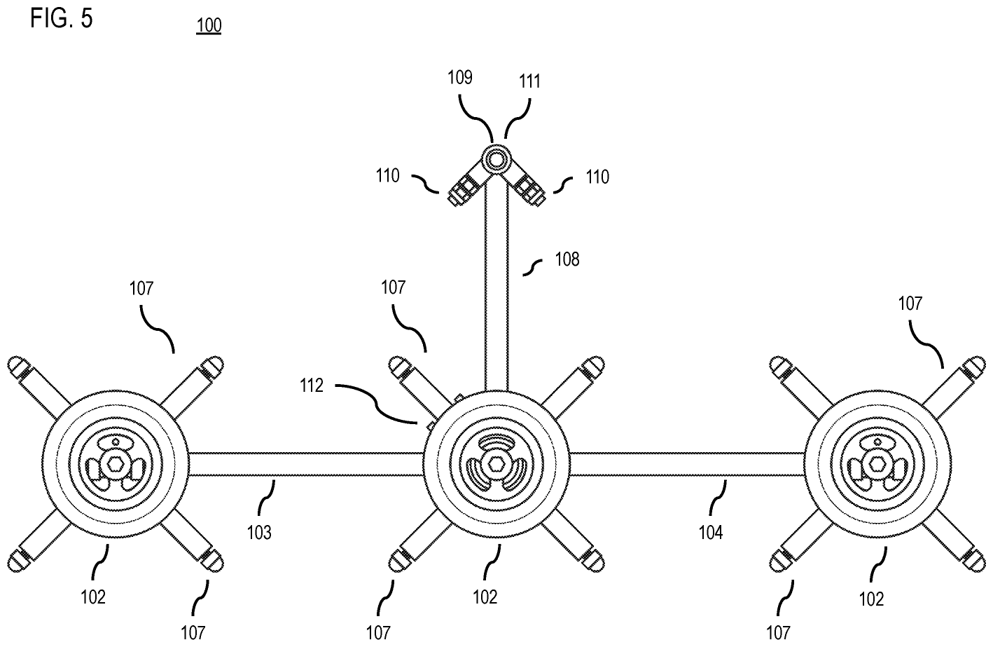

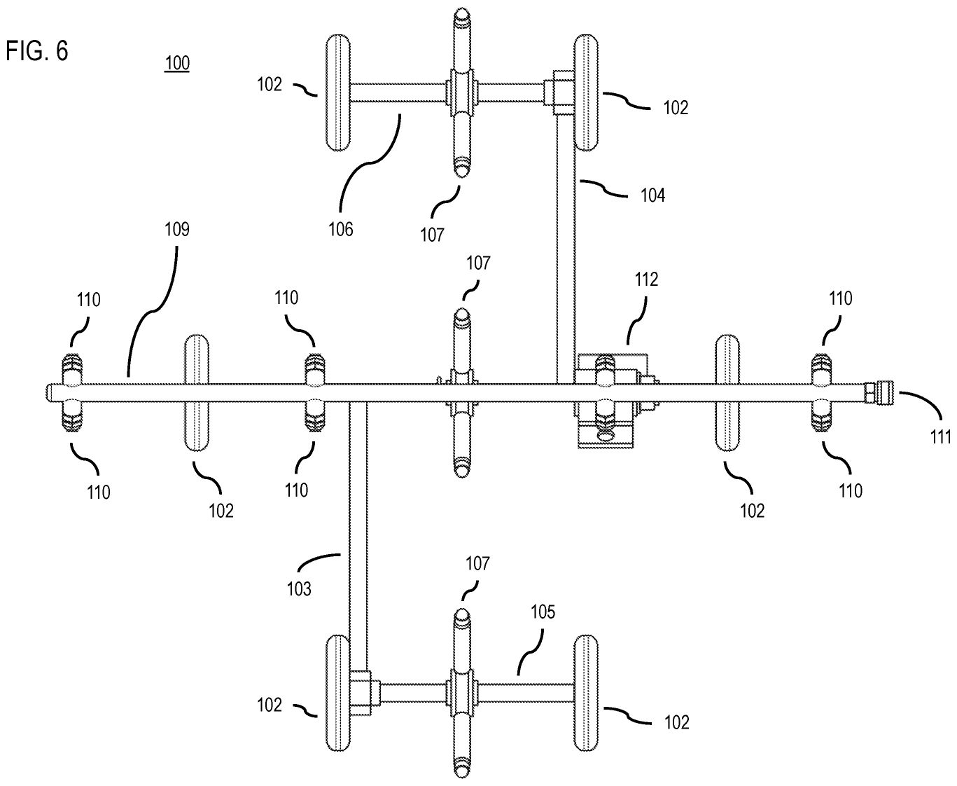

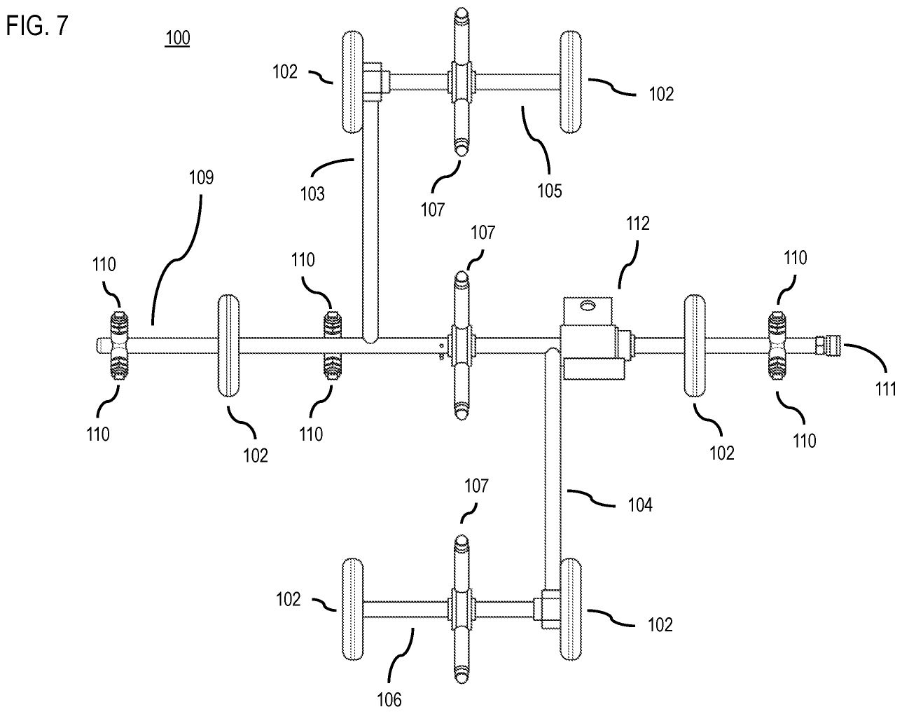

Further features and advantages of the invention, as well as the structure and operation of various embodiments of the invention, are described in detail below with reference to the accompanying FIGS. 1-11.

The present disclosure provides an device, apparatus, system, and method for cleaning or washing panels, such as photovoltaic panels.

According to an embodiment of the invention, the cleaner comprises a plurality of nozzles that are supplied with pressurized fluid. The pressurized fluid may comprise water and may further comprise additives such as soap or other additives that aid in cleaning, preserving, and/or treating the surface to be cleaned. The cleaner may also comprise a plurality of wheels that allow the cleaner to traverse the surface to be cleaned. The wheels are configured such that the cleaner can traverse multiple cleaning surfaces.

The cleaner may further comprise one or more guides. The guides locate the cleaner relative to surfaces to be cleaned and the gaps between the panels forming the cleaning surface. Each guide may have a plurality of substantially straight spokes extending outward from the guide. For example, the guides may be aligned in a substantially linear orientation. In such an embodiment, the guides can fit in between a gap between two panels. The guides may further be configured to rotate about an axis. In such an embodiment, the guides can rotate around an obstruction in the gap, such as a panel retainer that holds the panels in place. In an embodiment comprising multiple guides, the guides keep the panel cleaner oriented in a desired direction, i.e., in line with the panels, by having at least one guide spoke engaging the gap between the panels.

The cleaner may be manually powered. In such an embodiment, the cleaner may have a handle extending from the cleaner's structure. A user may use the handle to push or pull the cleaner along a plurality of panels. Other embodiments of manually powered cleaners comprise, for example, a rope, chain, or cord affixed to one end of the cleaner. In such embodiments, the user can place the cleaner at one end of a row of panels and pull the panel across the row of panels.

The cleaner may be powered. In some embodiments, the cleaner may comprise one or more motors that drive the cleaner across multiple panels. The motor may be powered by electricity or gasoline. In other embodiments, the cleaner may employ a hydraulic motor wherein the motor is driven by the hydraulic pressure of the pressurized fluid supplied to the cleaner.

Although the invention may be shown and described as being used to clean a photovoltaic panel, the cleaner can be used to clean any type of panel or surface that is substantially horizontal and/or angled, flat or curved, without departing from the embodiments contemplated herein.

In an exemplary embodiment of the present disclosure and with reference to FIGS. 1-7, the panel cleaner 100 comprises a first axle 101, a second axle 105, and a third axle 106. The second axle 105 is offset from the first axle 101 by a first longitudinal member 103. The third axle 106 is offset from the first axle 101 by a second longitudinal member 104. The panel cleaner 100 comprises a plurality of wheels 102. The second axle 105 and third axle 106 may be substantially parallel to first axle 101. In an embodiment, a wheel 102 is disposed at each terminal end of first axle 101, second axle 105, the third axle 106.

Although six wheels 102 are shown, the panel cleaner 100 may utilize any number of wheels 102 without departing from the contemplated embodiments. Wheels 102 may be constructed from any suitable rigid, semi-rigid, and/or pliable material, the implementation of which will be readily apparent to one skilled in the art. For example, wheels 102 may comprise an inner hub and a softer, pliable tire surrounding the inner hub. In such an example, the tire may be inflatable or solid. In some embodiments, wheel's 102 tires may be made from a soft material that will not damage panels 914. Additionally, any size wheel 102 and/or tire may be utilized without departing from the contemplated embodiments. In some embodiments, wheels 102 are sized such that their outer diameter is slightly smaller than the diameter defined by the guide nut's 1105 rotation about the guide hub's 1101 axis of rotation. In this way, the guide 107 will have the capability to reach a point lower than the wheels 102, allowing the guide 107 to engage an object below the surface on which wheels 102 ride.

The panel cleaner 100 may also comprise a manifold 109 comprising a plurality of nozzles 110 and a manifold fitting 111. Manifold 109 may be offset from first axle 101 by upright 108 Manifold fitting 111 may be of any suitable type of coupling to attach a hydraulic hose used to supply panel cleaner 100 with fluid. Exemplary types of manifold fittings 111 include but are not limited to a quick-disconnect hydraulic coupling, a ball-lock coupling, a roller-lock coupling, a pin-lock coupling, a flat-faced coupling, a bayonet coupling, a ring-lock coupling, or a cam-lock coupling. Additionally, although panel cleaner 100 is shown as implementing a single manifold 109 having a single manifold fitting 111, any number of manifolds 109 and/or manifold fittings 111 may be use without departing from the contemplated embodiments. For example, the panel cleaner 100 may use two manifolds 109, each having one or two manifold fittings 111. In such an embodiment, one of the manifolds 109 may be used to supply water to the nozzles 110 while a second manifold 109 is used to supply soap or other cleaning agent to nozzles 110. In such an embodiment, the panel washer may apply soap to a portion of the panel while also supplying water to another part of the same panel or a different panel. Additionally, some embodiments have a manifold fitting 111 at both ends of the manifold 109, allowing a supply hose to be connected at either or both ends of the manifold 109.

In an illustrative embodiment, the plurality of nozzles 110 are operatively connected to the manifold 109 such that the manifold 109 supplies fluid to the nozzles 110. The nozzles 110 may be operatively connected to the manifold 109 by any suitable means known in the art for providing fluid flow from the manifold 109 to the nozzles 110, such as by molded extensions integral with the manifold itself, an intermediate modular coupling, a pipe fitting, a valve fitting, other connections known in the art, or any combination thereof. The nozzles 110 may be formed together with the manifold 109 as a single component to simplify assembly. Alternatively, the nozzles 110 may be separate modular components, providing for easy removal, replacement, and cleaning.

The panel cleaner also comprises a plurality of guides 107. Although first axle 101, second axle 105, third axle 106 are shown as each comprising a single guide 107, any number of guides 107, including zero, may be used without departing from the contemplated embodiments. Although guides 107 are shown as having four spoke assemblies 1102, any number of spoke assemblies 1102 may be used without departing from the contemplated embodiments.

One or more of various components of panel cleaner 100 may be constructed from any suitable rigid or semi-rigid material. For example, first axle 101, second axle 105, third axle 105, upright 108, and many fold 109 may comprise polymers or metals, or a combination thereof. Additionally, one or more of the components may be constructed from composite materials such as fiberglass, carbon fiber, or carbon-Kevlar.

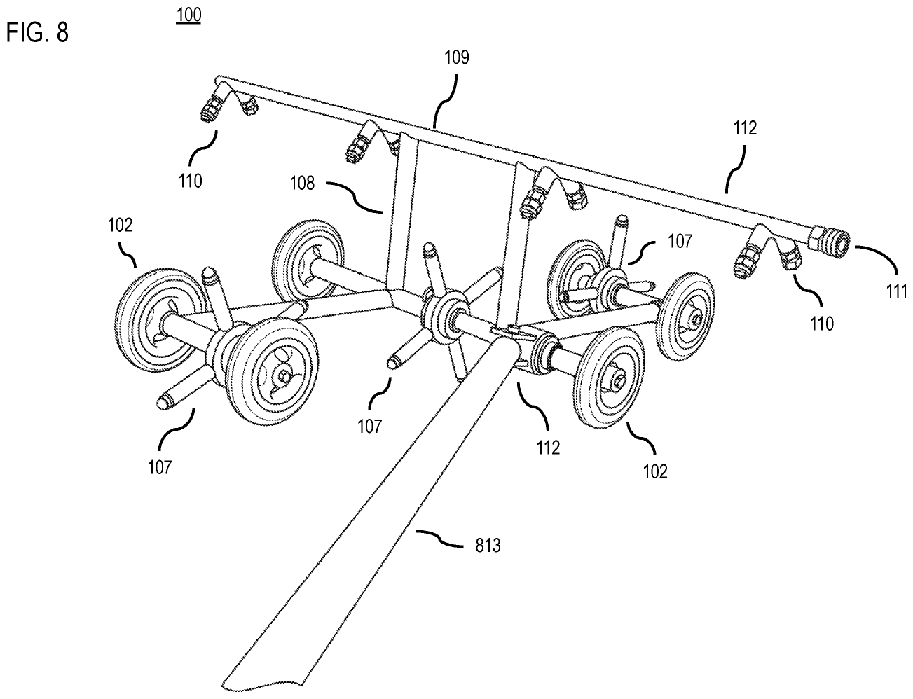

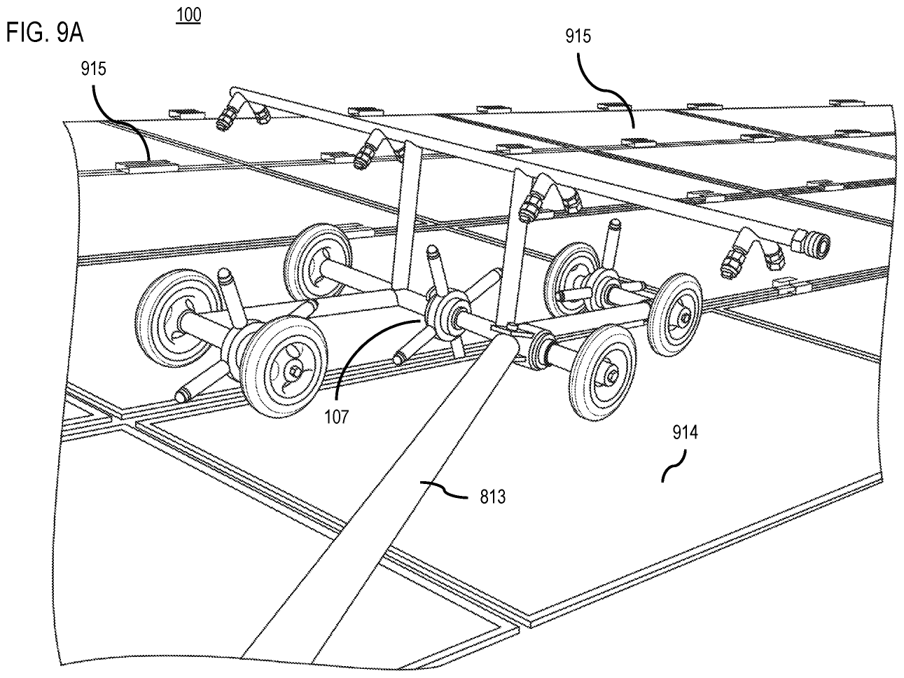

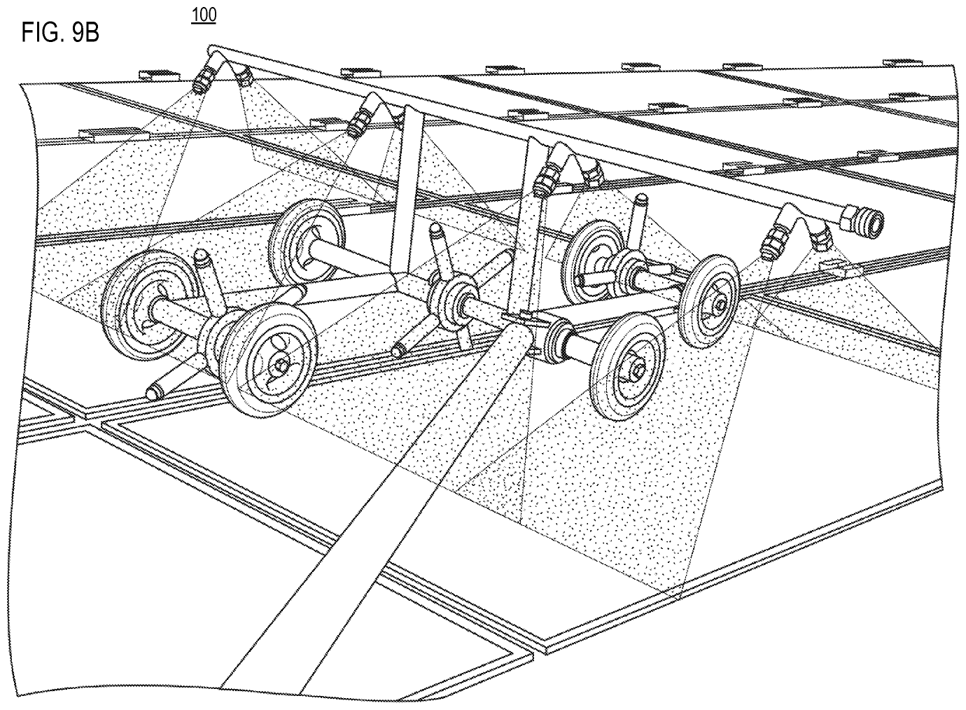

In another exemplary embodiment of the present disclosure and with reference to FIGS. 8-9B, the panel cleaner maintains directionality during use. In an embodiment, the spoke assemblies 1102 of guides 107 fit within the gaps between panels 914. In some embodiments, panels 914 may utilize panel retainers 915 to hold panels 914 in place. One or more of the guide spokes 1102 pass within the gap between panels 914. As the panel washer 100 moves along the panels 914, the guides maintain the panel washer's direction by maintaining a guide spoke 1102 within the gap between panels 914. Spoke tubes 1104 are rotatable about an axis defined by threaded rod 1103 to minimize the friction between spoke tube 1104 and the edge of panels 914. In an embodiment where the panels 914 utilize panel retainers 915, guide 107 rotates about an axis defined by hub assembly 1101. For example, guide 107 attached to first axle 101 rotates about first axle 101 when it encounters a panel retainer 915. As the panel cleaner 100 continues to move forward, guide 107 is rotated causing another guide spoke 1102 engage the gap between panels 914. In this way, the panel cleaner passively ensures that at least one spoke 1102 engages with the panel gap between panels 914, ensuring that panel cleaner 100 maintains its alignment.

Some embodiments also utilize handle 813. In such embodiments, handle 813 connects to the panel cleaner 100 at handle connector 112. In an embodiment, handle 813 connects to handle connector 112 using a pin-type connection. This allows a user to manipulate handle's 813 angle relative to panel cleaner 100 while still being rigidly connected to panel cleaner 100. In this way, a user can utilize handle 813 to push or pull the panel cleaner 100 along the surfaces of a plurality of panels 914 at different angles. Since panel arrays often comprise many rows of angled panels, such an embodiment allows the user to easily clean all the panels in the array from one side of the array. In some embodiments, handle 813 may comprise multiple sections that can be used to elongate or shorten the overall length of handle 813. In other embodiments, handle 813 may be telescopic. Handle 813 may be constructed from any suitable rigid or semi-rigid material, the implementation of which is readily apparent to one skilled in the art.

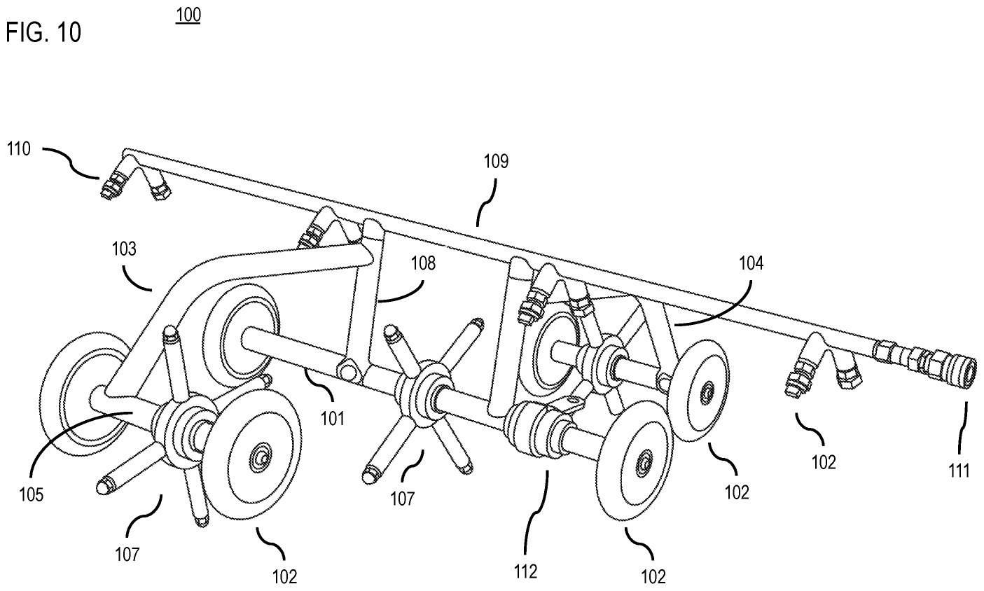

In another exemplary embodiment of the present disclosure and with reference to FIG. 10, various components of panel cleaner 100 may incorporate other sizes and shapes without departing from the contemplated embodiments. For example, first extension member 103 and second extension member 104 may be connected to uprights 108, maintaining its height relative to first axle 101 until bending toward and connecting to second axle 105 and third axle 106, respectively. In this way, nozzles 110 can spray panels 914 without being partially blocked by first extension member 103 or second extension member 104.

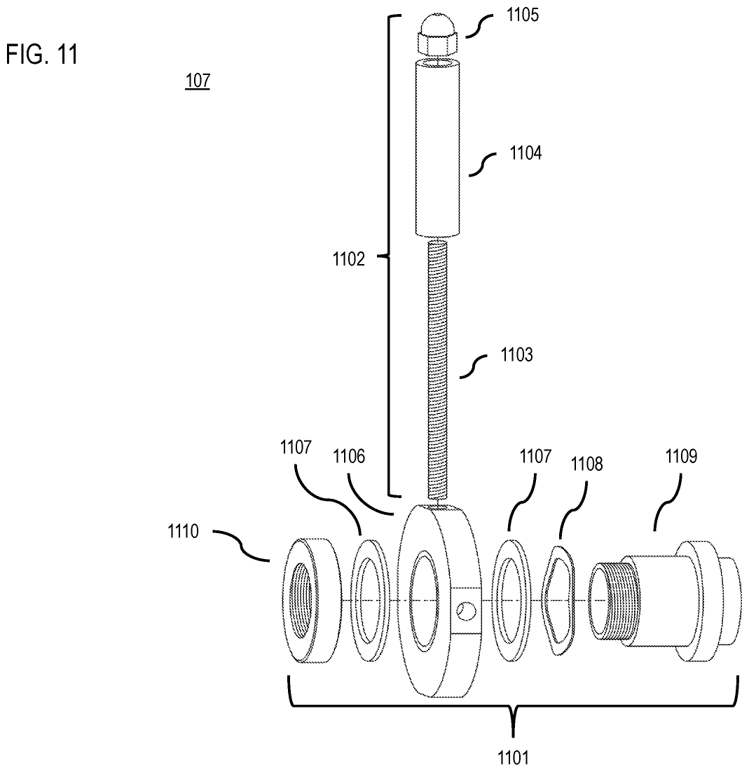

In another exemplary embodiment of the present disclosure and with reference to FIG. 11, the guide 107 comprises a hub assembly 1101 and spoke assembly 1102 extending radially from hub assembly 1101. In an embodiment, hub assembly 1101 comprises hub 1109, washers 1107, wave washer 1108, hub flange 1106, and hub nut 1110. Some embodiments include a bearing (not shown) that further facilitates the hub assembly's 1101 rotation about an axle (not shown) to which it is attached. In some embodiments, spoke assembly 1102 comprises threaded rod 1103, spoke tube 1104, and nut 1105. In the depicted embodiment, threaded rod 1103 attaches to a threaded hole in hub flange 1106. Tube 1104 is held in place relative to spoke assembly 1102 by nut 1105. In such an embodiment, spoke tube 1104 is free to rotate about threaded rod 1103. Some embodiments may comprise one or more bearings (not shown) that facilitate spoke tube's 1104 rotation about an axis defined by threaded rod 1103. Tube 1104 may be made from any suitable material, for example, a rigid or semi-rigid material such as metal, polymer, and/or plastic. Although only one spoke assembly 1102 is shown, any number of spoke assemblies 1102 may be implemented without departing from the contemplated embodiments. In other embodiments, the entire spoke assembly 1102 is rotatable about an axis defined by the concentric center of the spoke assembly 1102.

In some embodiments, the panel cleaner 100 is manually pushed or pulled along the panel array that is being cleaned, for example by a user pushing or pulling handle 813. In other embodiments, the panel cleaner is propelled. In some exemplary embodiments, panel cleaner 100 may comprise one or more motors that drive the panel cleaner 100 along the panel array. In such embodiments, an on-board electric motor may be used to drive one or more of wheels 102. In other embodiments that implement a motor do drive the panel cleaner 100, a hydraulic motor may be used. In such an embodiment, the hydraulic motor utilizes the hydraulic pressure of the fluid used to clean the panels to drive the motor. Such an embodiment has the added benefit of not needing an external power source to power the motor. In such an embodiment, a hydraulic motor uses the pressure of the water used to clean the panels to also drive the panel cleaner's movement. Various types of hydraulic motors include but are not limited to a vane motor, a gear motor, a gerotor motor, axial plunger motor, and a radial piston motor.

In other embodiments, the panel cleaner 100 may rely on other means of driving its movement. For example, panel cleaner 100 may use a guideline spool that, when triggered, draws in the guideline. In such an example, the panel cleaner 100 has a spool affixed to the cleaner 100. The panel cleaner 100 is place at one end of the panel array. The guideline is then drawn out of the spool and attached to the opposite end of the panel array. The spool is then triggered so that it slowly draws in the guideline into the spool. In doing so, the panel cleaner is drawn across the panel array. In other similar embodiments, the spool may be located external to the panel cleaner 100. In some embodiments, the hydraulic line supplying fluid to the panel cleaner 100 can also be used as the guideline.

In some exemplary embodiments, the panel cleaner 100 may also comprise one or more brushes or other cleaning aids. For example, panel cleaner 100 may utilize a plurality of brushes that are used to mechanically clean the panels 914. The brushes may be unpowered, i.e., passively clean the panels 914, or powered, i.e., actively clean the panels. In some embodiments, the panel cleaner 100 may implement multiple types of different cleaning aids, both powered and unpowered, without departing from the contemplated embodiments. Other exemplary cleaning aids include squeegees or other devices that help to remove water from panels.

In some embodiments, the panel cleaner 100 may comprise a reservoir. In such an embodiment, the reservoir may be located on the panel cleaner 100, i.e., an on-board reservoir, or located remotely. In such embodiments, the reservoir may hold, for example, biodegradable cleaners that assist the panel cleaner 100. An on-board reservoir may have the added benefit of lowering the center of gravity of the panel cleaner 100 because some panel arrays may be oriented at a steep angle relative to the ground.

In some embodiments, the length of the axles is variable. As shown, the length of first axle 101 is longer than second axle 105 and third axle 106. However, any length of axles may be used without departing from the contemplated embodiments. In some embodiments, the length of the axles is adjustable. For example, the panel cleaner 100 may be used on panel arrays that are very steep. In such uses, the axles may be elongated to help ensure the panel cleaner 100 maintains its orientation. In other uses where the panel arrays are not as steep or flat, a narrower overall profile might be desired. In such uses, the length of the axles may be shorted.

Although the invention is discussed as being used to clean photovoltaic panels, the present invention can be used to clean any type of panel without departing from the contemplated embodiments.

The invention has been described herein using specific embodiments for illustrative purposes only. It will be readily apparent to one of ordinary skill in the art, however, that the principles of the invention can be embodied in other ways. Therefore, the invention should not be regarded as being limited in scope to the specific embodiments disclosed herein, but instead as being fully commensurate in scope with the following drawings and claims.

I claim:

1. A panel cleaner comprising:
a manifold;
a plurality of nozzles operatively connected to the manifold, wherein the manifold supplies fluid to the plurality of nozzles;
a guide comprising a hub and a plurality of spokes extending radially from the hub, wherein the guide is rotatable about an axis defined by a concentric center of the hub; and
a plurality of wheels.

2. The cleaner of claim 1 further comprising:
a first axle, wherein the guide is attached to the first axle and the manifold is offset from the first axle via an upright;
a second axle oriented generally parallel to the first axle and offset from the first axle via a first extension; and
a third axle oriented generally parallel to the first axle and offset from the first axle via a second extension.

3. The cleaner of claim 2 further comprising a second guide attached to the second axle, the second guide comprising a plurality of spokes extending radially from a second hub, wherein the second guide is rotatable about an axis defined by a concentric center of the second hub.

4. The cleaner of claim 3 further comprising a third guide attached to the third axle, the third guide comprising a plurality of spokes extending radially from a third hub, wherein the third guide is rotatable about an axis defined by a concentric center of the third hub.

5. The cleaner of claim 2, wherein a first wheel of the plurality of wheels is disposed at a first terminal end of the first axle and a second wheel of the plurality of wheels is disposed at a second terminal end of the first axle opposite the first terminal end.

6. The cleaner of claim 5, wherein a third wheel of the plurality of wheels is disposed at a first terminal end of the second axle and a fourth wheel of the plurality of wheels is disposed at a second terminal end of the second axle opposite the first terminal end.

7. The cleaner of claim 6, wherein a fifth wheel of the plurality of wheels is disposed at a first terminal end of the third axle and a sixth wheel of the plurality of wheels is disposed at a second terminal end of the third axle opposite the first terminal end.

8. The cleaner of claim 1, wherein the guide comprises a bearing; and wherein each spoke rotates about an axis defined by its concentric center.

9. The cleaner of claim 1, wherein the guide comprises a bearing; and wherein a portion of each spoke rotates about an axis defined by the spoke's concentric center.

10. The cleaner of claim 1, further comprising a motor that drives at least one wheel of the plurality of wheels.

11. The cleaner of claim 10, wherein the fluid is pressurized and the motor is a hydraulic motor that is powered by the pressurized fluid.

12. The cleaner of claim 1, wherein the hub comprises a hub flange comprising a plurality of threaded holes perpendicular to the hub's rotational axis; and wherein each spoke of the plurality of spokes comprises:
a threaded rod threaded into a threaded hole of the plurality of threaded holes;
a spoke tube disposed around the threaded rod; and
a spoke nut threaded onto the threaded rod opposite the hub.

13. The cleaner of claim 12, wherein the spoke tube comprises a semi-rigid material.

14. The cleaner of claim 1 further comprising an on-board reservoir.

15. The cleaner of claim 1 further comprising a second manifold.

16. The cleaner of claim 1 further comprising a brush; wherein the panel cleaner is applied to photovoltaic panels.

17. A method of cleaning an array of panels with a panel cleaner, each panel positioned adjacent to at least one other panel forming a panel gap between said panels, the steps comprising:
inserting a guide spoke of a first guide within the panel gap, the guide spoke connected to a hub flange of a first hub assembly, wherein the first hub assembly is attached to a first axle;
spraying pressurized fluid from a plurality of nozzles operatively connected to a manifold, the manifold offset from the first axle by an upright; and
moving the panel cleaner over the surfaces of the panels in the array of panels using a plurality of wheels in a direction parallel to the panel gap in which the guide spoke is inserted.

18. The method of claim 17 further comprising inserting a guide spoke of a second guide within the panel gap, the guide spoke connected to a hub flange of a second hub assembly, wherein the second hub assembly is attached to a second axle.

19. The method of claim 17 further comprising inserting a guide spoke of a second guide within a second panel gap, the guide spoke connected to a hub flange of a second hub assembly, wherein the second hub assembly is attached to a second axle.

20. The method of claim 17, wherein the array of panels is an array of photovoltaic panels, and wherein the panel cleaner is moved along the array of panels using a motor driving at least one wheel of the plurality of wheels.
